(19) United States
(12) Patent Application Publication
(10) Pub. No.: US 2006/0252361 A1
(43) Pub. Date: Nov. 9, 2006

(54) Aerodynamic truck trailer airflow control device

(75) Inventor: Robert R. Henderson II, Salem, OR (US)

Correspondence Address: MARGER JOHNSON & MCCOLLOM, P.C., 210 SW MORRISON STREET, SUITE 400, PORTLAND, OR, 97204, US

(73) Assignee: Airman, Inc., Salem, OR (US)

(21) Appl. No.: 11/416,954

(22) Filed: May 2, 2006

Related U.S. Application Data
(60) Provisional application No. 60/678,810, filed on May 9, 2005.

(51) Int. Cl. B60H 1/00

(52) U.S. Cl. 454/118

(57) ABSTRACT

An aerodynamic airflow control device is preferably mounted either in a rigid or slidable manner to an underside of a truck trailer just forward of the trailer tires and axles to better manage airflow around the trailer tire and axle assembly. In operation, the device preferably collects and routs impinging air to exit between the trailer tires and under the trailer axles to reduce road spray while keeping tires and brakes running cooler and while further decreasing parasitic drag of the truck and trailer unit as it moves along the highway.

### CROSS-REFERENCE TO RELATED APPLICATIONS

This U.S. non-provisional patent application claims priority under 35 U.S.C. § 119 from U.S. Provisional Patent Application 60/678,810 filed May 9, 2005, the contents of which are hereby incorporated herein by reference in their entirety.

### BACKGROUND OF THE INVENTION

This invention relates generally to heavy truck trailers, and more specifically to an airflow control device that provides spray and splash control of trailer tire assemblies. It is well known by highway travelers that truck and trailers kick up voluminous amounts of splash and spray whenever the highways are wet. Various solutions have been proposed as a way to control spray and splash from truck trailers.

U.S. Pat. No. 4,262,953, issued Apr. 21, 1981 to McErlane (“McErlane”), shows undermounted air deflectors for truck trailers. These are airfoils or deflector panels mounted ahead of the rearmost set of wheels that direct the air down and around the deflector. These units direct the air around in a horizontal manner away from the centerline of the trailer and back parallel to the centerline of the trailer. This causes the air to impinge upon the rotating tires and increases spray and splash.

Similarly, U.S. Pat. No. 4,640,541, issued Feb. 3, 1987 to FitzGerald, et al. (“FitzGerald”), also discloses various undermounted air deflectors for truck trailers. Some of these deflectors are similar to those in McErlane in that they direct air away from a centerline of the vehicle. FitzGerald also, however, discloses an air deflector having a plurality of generally vertical grooves angled toward the centerline of the vehicle. These grooves direct impinging air downward and between the rear wheels.

U.S. Pat. No. 4,486,046, issued Dec. 4, 1984 to Whitney, et al. (“Whitney”), uses airstream deflectors on the underside of a semi-trailer that direct the air towards the centerline of the trailer tires. The water entrained air causes the rotating tires to spray and splash in a manner that is worse than without the unit.

What is needed is an aerodynamic truck trailer device that is easy to manufacture, that can flex in response to the strains of loading without becoming damaged, and that enables adjustable positioning. It is further desirable to have an aerodynamic truck trailer device that provides increased spray and splash control, cooler running tires, reduced aerodynamic drag, and enhanced trailer handling.

### SUMMARY OF THE INVENTION

An airflow control device constructed according to the principles of the present invention preferably uses air in a way that draws the air down to the highway surface and toward a centerline of the vehicle, thus substantially reducing splash and spray.

According to one embodiment of the present invention, an improved undermounted airflow control device may comprise a plurality of panels assembled together in a manner that permits them to collect and direct impinging air to exit between the trailer tires and beneath the axles. Using the airflow control device, the large volume of air collected and forced between the tires and beneath the axles increases in velocity as it exits, thereby producing a low-pressure area that further helps eliminate or substantially reduce splash and spray as the surrounding air is drawn into the low pressure area.

The airflow control device can be mounted rigidly or slidably to the underside of a trailer, preferably ahead of the rearmost trailer tire assembly to collect the incoming air. In a preferred embodiment, the incoming air preferably impinges on a panel or other means for deflecting air that extends all the way across from one outboard side of the trailer to the other, and that further preferably extends from the underside of the trailer down to approximately a lower portion of the trailer tire axles. The forward collection panel or panels are preferably sloped to decrease the parasitical drag on the trailer tire/axle assembly. The sloped panel or panels are further preferably angled sufficiently to direct all or a majority of the impinging air downwards towards the ground. The device may further have one or more panel sections arranged in a horizontal orientation to allow compression and columniation of the air and to direct it between the tires and under the axles.

The angled panels are most preferably supported on both sides by vertical panels attached to the underside of the trailer in a rigid or slidable manner. When slidably attached, the whole airflow control device is preferably enabled to be moved forward or back along the trailer, such as when the axles are moved. The side panels are preferably cut having an angle and depth that facilitate collection of the air. Ideally, most of the air impinging on the device should be forced to exit between the trailer tires and underneath the axles without increasing aerodynamic drag.

The vertical panels can further include separate, flexible extension panels that extend below the vertical panels and have a predetermined length and depth configured to reduce drag while capturing additional air to feed between the axles. The extension panels are preferably sufficiently flexibile to permit them to adapt to bumps or objects on the road. The lower flexible panels also preferably allow venting to prevent over pressurization and drag due to vehicle over speed or extreme headwind conditions. The flexible panels may be curved towards the centerline of the trailer to cause the exit air to cling to the outermost sides and be directed up and back to the rear of the trailer, thereby further keeping spray and splash from exiting in a transverse manner out into adjacent traffic lanes.

According to yet another aspect of the present invention, the means for deflecting air can comprise a plurality of air displacement panels connected to each other in a contiguous manner. The panels can be connected together, for instance, by attaching flanges or other surfaces of the panels to each other with double-sided construction tape or other adhesive material. In a most preferred configuration, the construction tape is made of a plastic or other medium that is deformable and resilient to compensate for the extreme movements and vibrations imposed on the trailer during loading, unloading, and traveling down the road, without experiencing connection failures. In an alternative embodiment, a flexible adhesive could be used in place of the construction tape.

Preferably, the air that is collected by the device is directed primarily between the tires proximal to a centerline of the vehicle. Air is preferably collected in the area between the outboard vertical panels. Excess air is preferably allowed to vent back in a tangential manner along the outside of the vertical panels. Between-tire exit airflow draws air past the tires, cooling the tires and brakes and reducing spray and splash.

Accordingly, several objects and advantages of the invention include providing increased spray and splash control, providing cooler running tires, reducing aerodynamic drag, and enhancing trailer handling. Other benefits obtained through the principles of the present invention include a more durable and resilient air deflecting member, adjustable positioning of the air displacement device, and improved manufacturing techniques. Still further objects and advantages will become apparent from a study of the following detailed description and the accompanying drawings.

### BRIEF DESCRIPTION OF THE DRAWINGS

The principles and features of the present invention will now be described more fully hereinafter with reference to the accompanying drawings showing various exemplary embodiments thereof, in which like numbers represent like elements, and in which:

FIG. 1 is a somewhat schematic side view of a truck and trailer having an airflow control device arranged thereon according to one embodiment of the present invention;

FIG. 2 is a somewhat schematic perspective view of the airflow control device of FIG. 1;

FIG. 3 is a somewhat schematic front elevation view of the airflow control device of FIG. 1;

FIG. 4 is a somewhat schematic top plan view of the airflow control device of FIG. 1, shown in relation to trailer support structures;

FIG. 5 is a somewhat schematic sectional front elevation view showing an uppermost portion of a right side panel of the airflow control device of FIG. 1, illustrating a method and mechanism for connecting the airflow control device to the trailer according to another aspect of the present invention;

FIG. 6 is a somewhat schematic side elevation view of a semi-truck and trailer unit having an airflow controller constructed according to principles of the present invention, further showing the direction of airflow during operation according to yet another aspect of the present invention; and

FIG. 7 is a somewhat schematic bottom plan view of the semi-truck and trailer unit of FIG. 6 further showing the airflow pattern during operation using an airflow controller constructed according to the principles of the present invention.

### DETAILED DESCRIPTION

The principles of the present invention will now be described more fully hereinafter with reference to various exemplary embodiments thereof. It should be recognized, however, that the invention may be embodied in many different forms and should therefore not be construed as being limited to any one or more of the embodiments set forth herein.

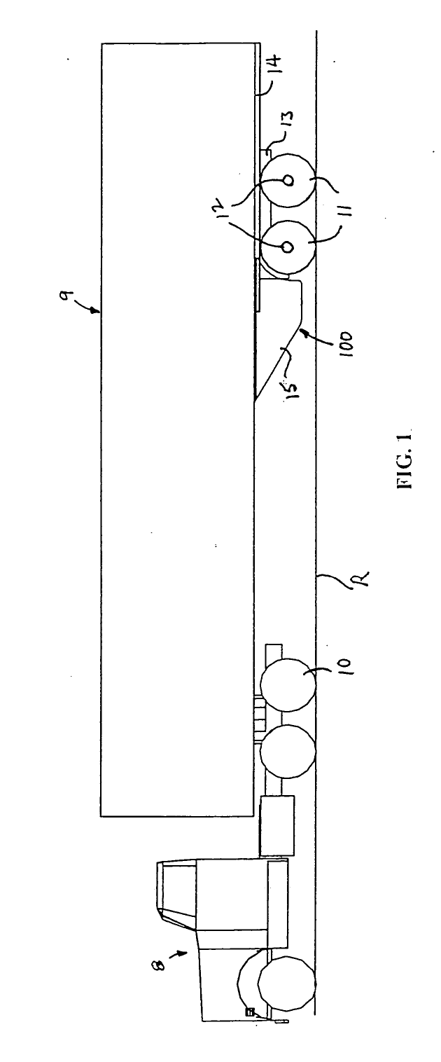

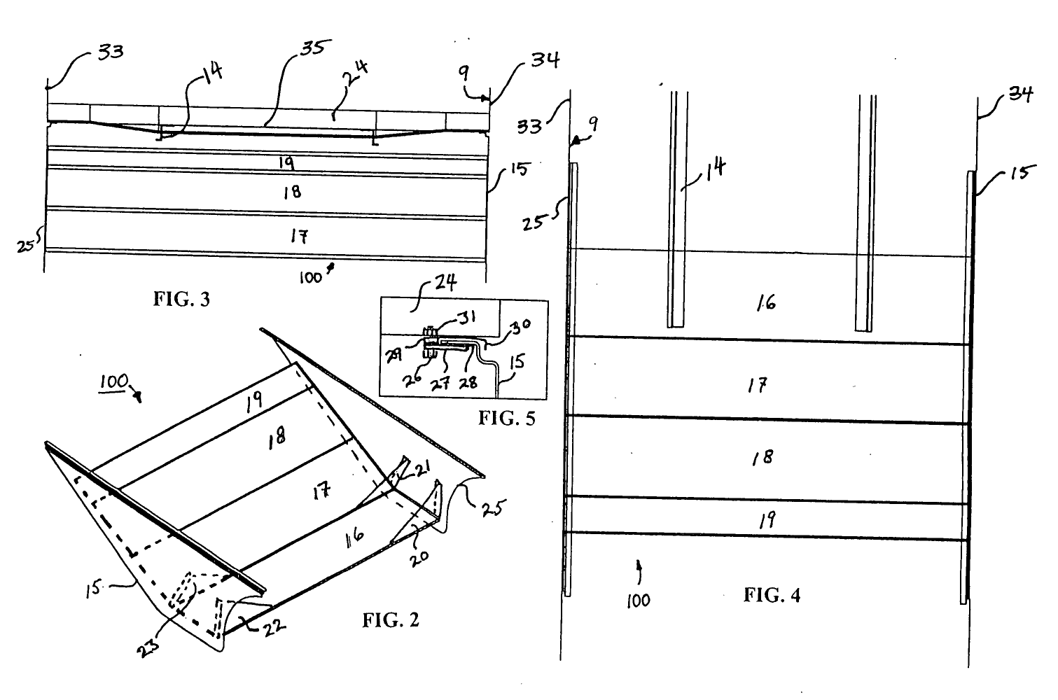

FIG. 1 is a somewhat schematic side elevation view showing a truck 8 and trailer 9 having an airflow control device I 00 constructed according to principles of the present invention. FIG. 2 is a somewhat schematic perspective view of the airflow control device 100 of FIG. 1, showing a preferred panel construction of the device 100. FIG. 3 is a somewhat schematic front elevation view of the airflow control device 100 of FIG. 1 arranged under the trailer 9, illustrating a relationship between the device 100 and an underside of the trailer 9.

Referring to FIG. 1, an airflow control device 100 preferably comprises an air deflector mounted under the trailer 9. The trailer 9 may include an axle slide member 14 that permits slidable movement of the axle/tire assembly frame 13. The trailer axles 12 have tires 11 rotatably mounted thereon, with the airflow control device 100 preferably positioned just ahead of the tires 11.

Referring additionally to FIGS. 2 and 3, the airflow control device 100 is preferably constructed from a plurality of panels 15, 16, 17, 18, 19, 25. A bottom columniation panel 16 is preferably connected to a sloped panel member that may comprise a plurality of sloped panels 17, 18, 19. Of course, any number or arrangement of panels can be used to provide the desired shape of the airflow control device. The panel assembly, or in this case, the uppermost sloped panel 19 is preferably shortened on an upper portion to avoid interference with the axle slide element 14, and particularly to permit the airflow control device 100 to be slid to the rear of the trailer 9.

Referring specifically to FIG. 3, the topmost sloped panel 19 in this embodiment is preferably configured so as not to interfere with a dropped cross-frame element 24 or the axle slide member 14. FIG. 3 shows the slide rail members 14 as viewed along the centerline of the trailer from front to back. The sloped panel can be shortened across its entire width as shown or can have cutouts (not shown) provided therein to permit passage of the slide rail members 14 as the device 100 is moved rearward.

Referring again to FIG. 2, a plurality of brace panels 20, 21, 22, 23 may also be provided. The brace panels 20, 21, 22, 23 are preferably connected between the vertical panels 15, 25 and the bottom panel 16 to provide lateral stiffness. Of course, any number or arrangement of brace panels can be used to provide the desired stability. Double-sided construction tape or other adhesive is preferably used to connect the brace panels 20, 21, 22, 23 to the vertical panels and the bottom panel 16. Double-sided construction tape or other adhesive can also be used to connect the bottom panel 16 to the bottommost sloped panel 17 and also to connect the sloped panels 17, 18, 19 to each other.

Referring now to FIGS. 1 through 3, the airflow control device 100 preferably collects and directs incoming air to an area between the outer sides of the trailer 9. More particularly, the incoming air impinges on a means for deflecting the air such as a panel, a plurality of panels, or some other structure for deflecting the air downward. The sloped panel or panels are preferably angled sufficiently to direct all or a majority of the impinging air towards the ground “R”. The device 100 may further include a lower panel section 16 arranged in a substantially horizontal orientation to allow compression and columniation of the air and to direct it between the tires 11 and under the axles 12.

In this embodiment, the means for deflecting air is preferably a plurality of panels 17, 18, 19 arranged to form a single contiguous structure having a substantially flat sloped surface extending to a substantially horizontal bottom panel 16. The means for deflecting air preferably extends from one outboard side of the trailer 33 to the other 34 and from near the underside of the trailer 29 down to approximately a lower edge of the trailer tire axles 12.

The angled panels 17, 18, 19 are further preferably supported on both sides by a pair of vertical panels 15, 25 attached to the underside 35 of the trailer 9 in either a rigid manner or in a slidable relationship. A slidable connection (see FIG. 5) allows the whole device 100 to be moved forward or back along the centerline of the trailer 9, such as when the axles 12 are moved. The side panels 15, 25 are preferably cut having a predetermined angle and depth that collects the air so that most of the air flowing rearward to the device 100 will be forced to exit between the trailer tires 11 and underneath the axles 12, thereby cooling the tires and reducing spray and splash while also reducing aerodynamic drag that would otherwise be created by the trailer tire assembly 11, 12, 13.

The vertical panels 15, 25 can also have flexible extension panels (not shown) having a predetermined length and depth configured to reduce drag while capturing additional air to feed between the axles 12. The flexible lower panels can also allow venting to prevent over-pressurization and drag that may result due to vehicle over-speed or extreme headwind conditions. The flexible panels are preferably curved towards the centerline of the trailer to cause the exit air to cling to the outermost sides and be directed up and back to the rear of the trailer 9, thereby helping to keep the spray and splash from exiting in a transverse manner out into adjacent traffic lanes.

The horizontal and sloped panels 16, 17, 18, 19 are preferably connected to each other in a contiguous manner with double-sided construction tape (not shown). A flange (also not shown) may be provided on each of the panels 16, 17, 18, 19 to provide additional connection surface. The tape is preferably made of a plastic or other resilient and durable medium that provides flexing capability for adapting to the extreme vibrations imposed on the trailer 9 during loading, unloading, and traveling down the road without experiencing connection failures. A flexible adhesive or other suitable connection medium could be used in place of the construction tape.

Similarly, the edges of panels 16, 17, 18, and 19 are preferably bent in an upward manner to provide surfaces that facilitate connection between those panels 16, 17, 18, 19 and the vertical panels 15, 25. As discussed previously, the panels 16, 17, 18, 19, 15, 25 may be connected together using double-sided construction tape, an adhesive material, or in another acceptable manner. When the panel connection surfaces are bonded together, the ensuing connections further act as stiffeners to provide additional stability.

As described above, the improved undermounted air deflector or air control device 100 preferably comprises a plurality of panels that are arranged to collect and direct the air to exit between the trailer tires 11 and underneath the axles 12. The large volume of collected air is thereby preferably forced into a smaller area and therefore increases its velocity as it exits behind the rear of the trailer. A low-pressure area is created, thereby further eliminating splash and spray as the surrounding air is drawn into the low pressure area. The sloped panels 17, 18, 19 further decrease the parasitical drag that would otherwise be present on the trailer tire/axle assembly 11, 12, 13. The vertical panels 15, 25 also help provide stability to the trailer 9 even in crosswinds. Accordingly, the principles of the present invention provide increased spray and splash control, cooler running tires, reduce aerodynamic drag, and enhance trailer handling.

FIG. 4 shows a preferred placement of the slide rails 14 on the bottom of the trailer 9 (as viewed from the top as if the trailer box was transparent) as well as a preferred placement of the airflow control device 100. Referring to FIG. 4, the airflow control device 100 is preferably arranged with a forward end in front of the slide rails 14 and a rearward portion including a portion of columniation panel 16 arranged behind a forward end of the slide rails 14. The vertical sidewalls 15, 25 preferably extend even further rearward than the bottom panel 16.

FIG. 5 illustrates a connection between the airflow control device 100 and the trailer 9 according to yet another aspect of the present invention. Referring to FIG. 5, the upper edges of the vertical panels 15 can be formed to provide a means for connecting to many different trailer cross-frame designs. More specifically, an upper end of the vertical panels 15, 25 is preferably formed with a step-like structure so that it can mate with numerous different trailer cross-frame designs. The step-like structure helps avoid interference with trailer structures that may extend beyond an underside of the trailer near the trailer sidewalls. The vertical panels 15, 25 can be rigidly bolted to the trailer subframe 24 using a bolt and nut combination 26 and 31. A slidable connection could also be provided.

To provide a slidable connection, the structure depicted in FIG. 5 could be used with an adequate length of each of the various materials. For example, a rigid material 27 could be sandwiched with a slick material 28, a spacer material 29, and a capture element 30, each having a sufficient length to provide the desired degree of slidability. This structure also provides a means for attaching the whole device 100 to many different possible subframe elements 24 found under the different trailers 9. This means for slidably attaching the device 100 to the trailer subframe 24 permits the device 100 to be moved forwards and rearwards along the trailer subframe 24, such as when the tire/axle assembly 13 is moved.

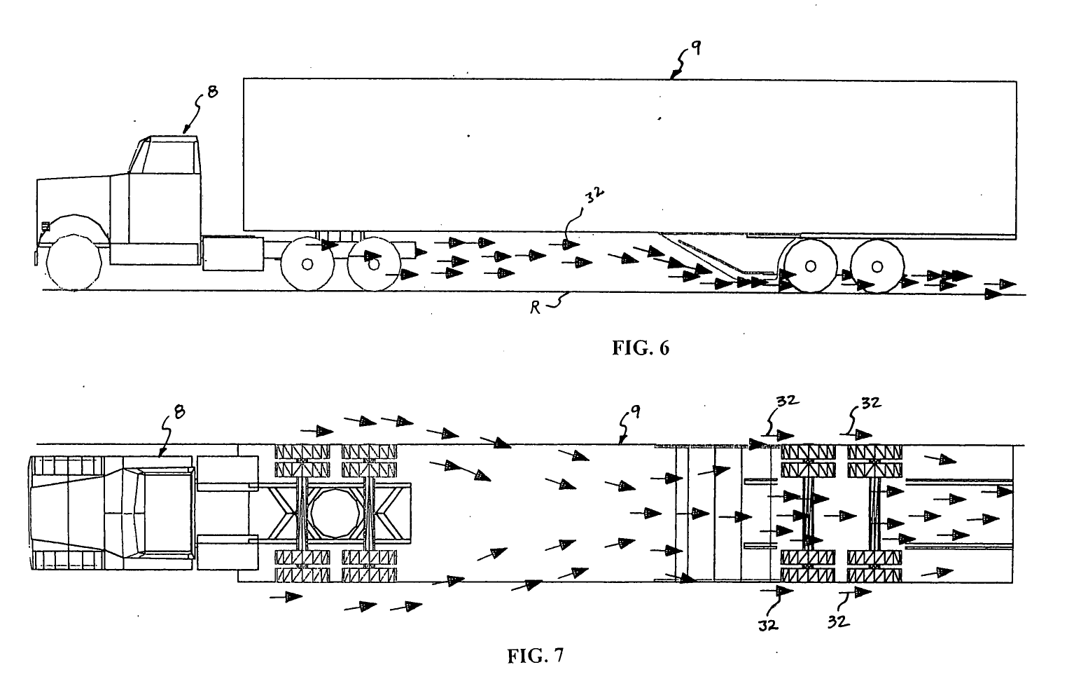

FIG. 6 is a side elevation view of a truck 8 and trailer 9 having the airflow control device 100 according to one embodiment of this invention, showing how air travels past the truck 8 and trailer 9 as it travels down the highway. FIG. 7 is a bottom plan view of the truck 8, trailer 9, and airflow control device 100 of FIG. 6, showing how the air moves in past the drive tires of the power unit and then impinges upon the sloped panels of the device 100. Referring to FIGS. 6 and 7, according to various principles of the present invention, as air travels past the forward drive tires, most of the air is then routed between the trailer tires 11 and exits the rear of the trailer 9 at a higher velocity than the surrounding air. A lower pressure area is therefore created that draws in surrounding air. In FIG. 7, for instance, excess air is shown venting out in a tangential manner beyond the vertical panels 15, 25 and can be seen returning towards the centerline of the trailer 9 because of the lower pressure area created by the airflow control device 100.

More particularly, air collected by the device 100 is directed to exit between the tires. Most of the air collected between the opposing outboard vertical panels 15, 25 is used and directed downward between the tires near a centerline of the vehicle. Excess air is allowed to vent back in a tangential manner along the outside of the vertical panels 15, 25 as indicated by airflow arrows 32. The between-tire exit air draws air past the tires and reduces spray and splash by creating a lower pressure area that draws tangential splash back inward and by further urging the air downward and preventing the large area of turbulence that would otherwise exist behind the trailer.

In operation, the device 100 collects the air that impinges upon the sloped panels 17, 18, 19 and keeps most of it from exiting laterally by the vertical panels 15, 25. Extension of the vertical panels 15, 25 beyond the sloped panels 17, 18, 19 by a predetermined distance helps avoid unnecessary aerodynamic drag and further helps provide lateral stability. Additional flexible extension panels (not shown) can further assist in this purpose. The easiest airflow path is for the air to exit downward towards the ground and back between the trailer tires 11 and beneath the trailer axles 12. The ensuing pressurized air is therefore forced to exit at a greater velocity, thus forming a negative pressure area between the tires. This low-pressure area now draws air from beyond the trailer tires towards the centerline of the vehicle bringing with it any rain or moisture from the roadway. The air is forced continually towards the rear of the trailer 9 as the device 100 and trailer 9 continue forward down the road “R”. The air exits the rear of the trailer 9 at a velocity that creates a low-pressure area behind the trailer. This air draws the surrounding air downward around the vertical corners of the trailer and thus further removes the low pressure area that is generally found at the back doors of the trailer. The principles of the present invention therefore significantly reduce road spray by keeping it down low to the roadway and toward the centerline of the truck and trailer. Aerodynamic efficiency is also significantly improved.

Although the present invention has been described above in connection with various particular embodiments of the present invention as illustrated in the accompanying drawings, it should be noted that the invention is not limited to those embodiments. Rather, it will be apparent to those of ordinary skill in the art that various substitutions, modifications, and additions may be made thereto without departing from the spirit and scope of the invention as encompassed by the appended claims.

What is claimed is:

1. An airflow control device for a truck trailer, said device comprising:
a sloped front panel configured to direct impinging air downward toward a road surface; and
two or more vertical panels, wherein at least one vertical panel is connected on each lateral end of the sloped front panel, and wherein said vertical panels extend beyond a lower surface of the sloped front panel to channel airflow between the vertical panels.

2. An airflow control device according to claim 1, wherein the device further comprises a lower panel arranged behind the sloped front panel in a substantially horizontal orientation to facilitate compression and columniation of the impinging air.

3. An airflow control device according to claim 1, wherein the sloped front panel comprises a plurality of panels connected together to provide a substantially planar downwardly sloping outward surface.

4. An airflow control device according to claim 3, wherein the plurality of panels are connected together using double-sided construction tape.

5. An airflow control device according to claim 1, further comprising one or more extension panels arranged to extend below a lower edge of the vertical panels.

6. An airflow control device according to claim 5, wherein the extension panels are constructed of a flexible material to enable them to adapt to road surface features and to further enable them to vent excess air from between the vertical panels.

7. An airflow control device according to claim 6, wherein the extension panels are curved inwardly to direct incoming air toward a centerline of the device.

8. An airflow control device according to claim 1, wherein the vertical panels comprise a downwardly sloping forward edge.

9. An airflow control device according to claim 1, further comprising a slidable attachment mechanism configured to slidably attach the airflow control device to an underside of a truck trailer.

10. An airflow control device according to claim 1, wherein an upper end of each of the vertical panels comprises an attachment mechanism for attaching to a trailer, and wherein an upper end of the vertical panels has a step-like shape to facilitate connection to multiple trailer types.

11. A method of constructing an airflow control device for a truck trailer, said method comprising:
forming a plurality of substantially planar panel members, each panel member having a length sufficient to extend substantially from one sidewall of the trailer to an opposing sidewall of the trailer;
connecting the plurality of panel members together to form a downwardly sloping forward surface and a substantially horizontal lower surface;
connecting the plurality of panel members to vertical sidewalls arranged on opposing lateral sides of the panel members, wherein said vertical sidewalls extend below the downwardly sloping forward surface and the substantially horizontal lower surface.

12. A method according to claim 11, wherein the plurality of panel members are connected together using double-sided construction tape.

13. A method according to claim 12, further comprising attaching a plurality of bracing members between the plurality of panel members and the vertical sidewalls to provide additional stability.

14. A method according to claim 11, further comprising configuring an upper end of the vertical sidewalls to have an inward step-like structure to facilitate attachment to multiple trailer configurations.

15. A method according to claim 11, further comprising connecting the airflow control device to a trailer in a slidable relationship.

16. A method of reducing road spray and splash from a truck trailer, said method comprising:
directing airflow impinging on a forward surface of an airflow control device downward below a trailer axle;
retaining a substantial portion of the air between opposing sidewalls of the trailer; and
creating a low-pressure area behind the airflow control device and between the opposing sidewalls of the trailer.

17. A method according to claim 16, further comprising using vertically-oriented panel members to improve trailer handling.

18. A method according to claim 17, wherein the vertically-oriented panel members are arranged on opposing lateral sides of the airflow control device proximal to the opposing sidewalls of the trailer, and said method further comprising using flexible panel members extending below the vertically-oriented panel members to further control a flow of air impinging on the device to further reduce road spray.

19. A method according to claim 16, further comprising slidably arranging the airflow control device on the trailer to permit forward and rearward movement of the airflow control device with respect to the trailer.

20. A method according to claim 16, further comprising using a substantially planar panel member arranged on a lower portion of the airflow control device to compress and columnize compressed air beneath the trailer axle.
